(19) United States
(12) Patent Application Publication
(10) Pub. No.: US 2014/0372083 A1
(43) Pub. Date: Dec. 18, 2014

(54) DERIVED RESTRICTIONS IN A COMBINATORIAL MODEL

(71) Applicant: International Business Machines Corporation, Armonk, NY (US)

(72) Inventors: Chein-Jen Hsu, Morrisville, NC (US); Sharon Keidar-Barner, Megiddo (IL); Itai YOSEF Segall, Tel-Aviv (IL); Rachel Tzoref-Brill, Haifa (IL); Aviad Zlotnick, Mitzpeh Netofah (IL)

(21) Appl. No.: 13/916,619

(22) Filed: Jun. 13, 2013

(51) Int. Cl. G06F 17/50

(52) U.S. Cl. CPC G06F 17/5009
USPC 703/1

(57) ABSTRACT

A method, apparatus and product for determining a derived restriction in a combinatorial model. The method comprising: obtaining a combinatorial model defining a test space, the combinatorial model comprising a set of attributes, a respective domain for each attribute, and a set of restrictions, wherein the restrictions define a combination of values of the attributes that are restricted from the test space; and automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

### TECHNICAL FIELD

The present disclosure relates to testing in general, and to testing using combinatorial models, in particular.

### BACKGROUND

A combinatorial model, also referred to as Cartesian-product model, is a set of attributes, values for the attributes (also referred to as domains), and restrictions on value combinations that may not appear together. Such a model spans a space of valid tests: each combination of values to the attributes that does not violate any restriction corresponds to a valid test.

Combinatorial models have a variety of usages. One such usage is functional coverage analysis of a System Under Test (SUT). Another usage is in Combinatorial Test Design (CTD). CTD is a test planning technique that selects a small subset of the valid test space that covers a predefined coverage goal. The coverage goal may define an interaction level of attributes that are to be covered, such as every n-wise combinations of values.

Preparing a combinatorial model may be a difficult task for a user, such as a verification engineer, a QA staff member, or the like. In particular, correctly capturing the restrictions over the model may be an important yet work-intensive and non-trivial task. Under-restricting the model may yield tests that cannot be executed and may cause coverage gaps if such tests are skipped or manually modified. Over-restricting the model also yields coverage gaps in the areas that are wrongly restricted.

### BRIEF SUMMARY

One exemplary embodiment of the disclosed subject matter is a computer-implemented method performed by a computerized device, comprising: obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

Another exemplary embodiment of the disclosed subject matter is a computerized apparatus having a processor, the processor being adapted to perform the steps of: obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

Yet another exemplary embodiment of the disclosed subject matter is a computer program product comprising: a non-transitory computer readable medium retaining program instructions, which instructions when read by a processor, cause the processor to perform a method comprising: obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a flowchart diagram of a method, in accordance with some exemplary embodiments of the disclosed subject matter;

FIG. 1B shows a flowchart diagram of a method, in accordance with some exemplary embodiments of the disclosed subject matter;

FIG. 2 shows a flowchart diagram of a method, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to identify derived restrictions of a combinatorial model. Another technical problem is to provide the user with an output useful for understanding the derived restrictions to allow the user to determine whether the combinatorial model is accurate or not.

A combinatorial model defines a test space that is an aggregation of coverage tasks that can be tested. Each coverage task is a full assignment of values to a set of attributes. The assigned values are selected from a respective domain of each attribute. A coverage task may be restricted from the test space using a restriction. The restriction may define a partial assignment to the attributes that is restricted. As an example, in a model having four attributes A, B, C, D each being associated with a respective domain D_{A}={a₁,a₂}, D_{B}={b₁,b₂}, D_{C}={c₁,c₂}, D_{D}={d₁,d₂ }. A restriction A=a₁ [symbol] B=b₁ excludes from the test space all coverage tasks that assign the value of a₁ to A and the value b₁ to B.

In some cases, several restrictions may together exclude combinations of partial assignments that are not restricted by any of the restrictions alone. Such excluded combinations are referred to as derived restrictions. The derived restrictions may exclude combination of values that the user who defined the restrictions did not originally intend to exclude.

A restriction that is defined explicitly in the model and is not a derived restriction may be referred to as an explicit restriction.

Referring again to the model above, in addition to the first restriction (A=a₁ [symbol] B=1) there may be defined a second restriction excluding B=b₂ [symbol] C=c₂. Each restriction, on its own, does not restrict the partial assignment of A=a₁ [symbol] C=c₂. However, when taken in combination, the two restrictions exclude each such assignment as if B is assigned b₁ then the first restriction excludes it and if B is assigned b₂ then the second restriction excludes it. In this example, there is no explicit restriction excluding A=a₁ [symbol] C=c₂, but there is a derived restriction excluding such partial assignment. The derived restriction may be unintentional and may expose a mistake in the existing restrictions.

One technical solution provided by the disclosed subject matter is to automatically determine derived restrictions based on restrictions defined explicitly in the model. The determination may be performed by determining all excluded coverage tasks and performing hole analysis thereof. Hole analysis is explained, for example, in Lachish et al., “Hole Analysis for Functional Coverage Data”, Design Automation Conference, 2002. Proceedings. 39^{th} (2002), 807-812, which is hereby incorporated in its entirety. The determined holes may be compared with the restrictions defined in the model to identify holes that are derived from more than a single restriction.

In some exemplary embodiments, Binary Decision Diagrams (BDDs) may be utilized to represent the excluded coverage tasks and to allow for relatively efficient computation of the holes comparison with the explicit restrictions.

In some exemplary embodiments, a Boolean Satisfiability Problem solver, also referred to as a SAT solver, may be utilized. The restrictions may be formulated using Conjunctive Normal Form (CNF) formulas that are fed to the SAT solver. The SAT solver may perform resolution steps during which based on two or more clauses, an additional clause is deduced. Such additional clause, also referred to as a resolution clause, may be deemed as a derived restriction.

In some exemplary embodiments, the user may be provided with an output listing the restrictions of the model. Derived restrictions may be listed and displayed in a different manner, such as using a different color, font, or the like. In some exemplary embodiments, the list may indicate which restrictions were added, removed and/or modified since a previous base-line, such as previous version of the model, previous selected version of the model, or the like.

One technical effect of utilizing the disclosed subject matter is to allow a user, such as a verification engineer, a QA staff member, a developer, or the like, to better understand the combinatorial model. The derived restrictions may be hard to comprehend and manually identify. Providing the user with a list of derived restrictions may allow the user to determine whether they are indeed correct restrictions or whether they are a result of over-restricting, or of other modeling mistakes, e.g. a missing value such as a missing value in the domain of B. In the example given above, the user may determine that the restriction A=a₁ [symbol] C=c₂ is not correct and may decide to modify one restriction. As an example, restriction B=b₂ [symbol] C=c₂ may be modified to refer to attribute A or D.

Another technical effect is providing succinct information regarding the restricted portion of the test space. The derived restrictions that are displayed may be the broadest restrictions, also referred to a restriction of the highest level. A restriction

$${⋂}_{i ∈ K} {Attribute}_{i} = {value}_{i}$$

is a broadest restriction if for each attribute in the restriction (Attributeⱼ), there exists at least one coverage task that is not excluded from the test space that assigns the values to according to the restriction except for the Attributeⱼ (e.g.

$${⋂}_{i \neq j , i ∈ K} {Attribute}_{i} = {value}_{i} ) .$$

In other words, each subset of the restriction is not on its own a restriction. Broadest restrictions are restrictions that are not subsumed by any other single restriction. Referring, again, to the above mentioned example, restriction B=b₂ [symbol] C=c₂ [symbol] D=d₂ is not a broadest restriction because the assignment of value to attribute D may be removed, and the assignment B=b₂ [symbol] C=c₂ would still be a restriction.

It will be understood that each extension of the partial assignment of a restriction (e.g., requiring an assignment of a value to additional one or more attributes) is also excluded from the test space.

The derived restrictions may be provided in succinct manner to allow the user to understand them without introducing unnecessary noise, such as assignment of values to attributes that do not modify the nature of the restriction. Only coverage gaps of the highest level are reported to the user.

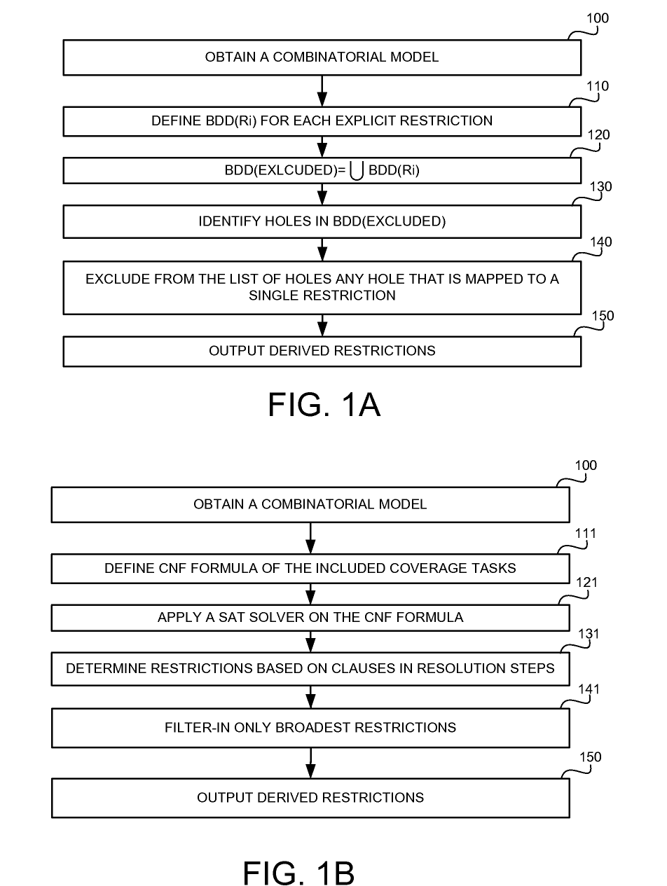

Referring now to FIG. 1A showing a flowchart diagram of a method, in accordance with some exemplary embodiments of the disclosed subject matter.

In Step 100, a combinatorial model is obtained. The model may be provided by a user that manually defines the explicit restrictions. Additionally or alternatively, the model may be defined automatically.

In Step 110, a BDD may be defined for each explicit restriction. A BDD is a data structure that can be used for representing a group of values. For each explicit restriction (denoted Rᵢ) a BDD may be defined (denoted BDD(Rᵢ)). The BDD may include all coverage tasks that are restricted by the explicit restriction.

In Step 120, a BDD that represents all excluded values may be defined by disjuncting the BDDs for all the explicit restricting. In some exemplary embodiments, the computation may be performed by calculating

$$BDD ( EXCLUDED ) = {⋃}_{i} BDD ( {R}_{i} ) .$$

BDD(Excluded) may represent the group of all the coverage tasks that are excluded from the test space.

In Step 130, hole analysis may be performed with respect to BDD(Excluded) to determine a set of partial assignments that represent the entire group. Each partial assignment determined by hole analysis may be associated with a broadest restriction. The list of holes may be deemed as the list of explicit and derived restrictions.

Referring to the example above, the holes analysis may include three partial assignments: A=a₁ [symbol] B=b₁; B=b₂ [symbol] C=c₂; A=a₁ [symbol] C=c₂. In some exemplary embodiments, the holes analysis may be performed on a BDD data structure and may result in a BDD for each hole (e.g., BDD(hole₁)≡A=a₁ [symbol] B=b₁; BDD(hole₂)≡B=b₂ [symbol] C=c₂; BDD(hole₃)≡A=a₁ [symbol] C=c₂).

In some exemplary embodiments, the hole analysis may be performed with respect to a coverage requirement. The coverage requirement may define a level of interaction between attributes (e.g., n-wise interaction). In some exemplary embodiments, the coverage requirement may define the interaction with respect to a specific subset of attributes and/or assignments of values to attributes. The coverage requirement may be used, for example, when performing CTD to define levels of desired interactions. The hole analysis may accordingly be limited to holes that are relevant to the same coverage requirement, such as only include holes that are within the requirements of the coverage requirement (e.g., number of attributes is not larger than the level of interaction, the attributes are selected from the subset defined by the coverage requirement, or the like).

In Step 140, the holes may be compared with the explicit restrictions to identify holes that are mapped directly to a single restriction (e.g., hole₁ and hole₂ in the example above). Such holes may be removed from the list of holes to provide a list of derived restrictions.

In some exemplary embodiments, determining whether a hole is mapped to a single restriction may be performed by comparing the BDD of the hole with the BDD of the restriction. For example, as BDD(hole₁)=BDD(R₁), it can be determined that the first hole is mapped directly to the first restriction. As another example, as BDD(hole₃)≠ BDD(R₁) and BDD(hole₃)≠ BDD(R₂), the third hole is a not mapped directly to any explicit restriction and represents a derived restriction. Additionally or alternatively, it may be checked whether the BDD of the hole is subsumed by a BDD of the restriction (e.g., BDD(holeᵢ)⊂ BDD(Rₖ)). Additionally or alternatively, the following may be computed: BDD(holeᵢ)→BDD(holeᵢ) [symbol] BDD(Rₖ)

In Step 150, the derived restrictions may be outputted to a user. In some exemplary embodiments, the output may include a list of restrictions that may or may not also include the explicit restrictions. In some exemplary embodiments, the derived restrictions may be displayed in a different manner than explicit restrictions (e.g., using different color or using other visual cues) to direct the user's attention to the difference between the two types of restrictions.

In some exemplary embodiments, the method of FIG. 1A may be triggered by a change in the coverage requirements or in the model, thereby reflecting each such modification to the user. Additionally or alternatively, the method may be performed in response to a command from a user that indicates that the user would like to view a report, such as a report of all restrictions, report of the derived restrictions, or the like.

In some exemplary embodiments, the disclosed subject matter may retain a single BDD to represent several holes. As an example, if two holes are associated with the same two attributes they may be represented using a single BDD. Still in this example, if a first hole is A=a₁ [symbol] B=b₁ and a second hole is A=a₁ [symbol] B=b₂, a single BDD may be used to represent the two holes by representing (A=a₁ [symbol] B=b₁) [symbol] (A=a₁ [symbol] B=b₂). In some exemplary embodiments, holes that use a subset of common attributes may be represented together using a single BDD. Several such BDDs may be used to represent all the holes determined by the method of FIG. 1A.

Referring now to FIG. 1B showing a flowchart diagram of a method, in accordance with some exemplary embodiments of the disclosed subject matter.

Based on the combinatorial model that is obtained (Step 100), a Conjunctive Normal Form (CNF) formula may be determined to define the included coverage tasks (Step 111). The CNF formula may be a conjunction of clauses, each of which is a disjunction of literals assigning value to a binary variable. A SAT Solver may be applied to solve the CNF formula (Step 121). During the operation of the SAT Solver, resolutions steps may be performed during which two clauses are used to deduce an additional clause. Resolution steps may be performed for two clauses of the type (x [symbol] A), ( x̅ [symbol] B), where x is a variable, A and B may be any clauses, the deduced clause of a resolution step may be (A [symbol] B). It will be further noted that Boolean Constraint Propagation (BCP) is a special case of a resolution step.

All clauses determined during resolution steps may be collected (Step 131), each of which may correlate to a derived restriction. Referring to the same example above, in view of the deduced clause (A [symbol] B), a restriction that ( [symbol] A [symbol] [symbol] B) is a derived restriction. The derived restrictions may be outputted to the user (Step 150).

In some exemplary embodiments, the restrictions determined during the resolution steps may be filtered to include only broadest restriction. In Step 141, each restriction may be compared with other restrictions to determine whether it is subsumed by any of the other restrictions. If a restriction is subsumed in another restriction it may be excluded from the list of broadest restrictions.

Consider the following example which makes use of a SAT solver: denote legal_CNFᵢ as a CNF that is based on a restriction. Assuming there are three restrictions: R₁=(a [symbol] b̅), R₂=(c [symbol] b), R₃=(d [symbol] c̅ [symbol] ā), three legal_CNF clauses may be defined as follows: Legal_CNF₁=(ā [symbol] b), Legal_CNF₂=( b̅ [symbol] c̅), Legal_CNF₃=( d̅ [symbol] c [symbol] a). A single CNF may be defined to include all the test cases by conjuncting the Legal_CNF clauses:

$$TestSpace = {⋀}_{i} {Legal\_CNF}_{i} .$$

A SAT solver may be utilized to determine clauses based on one or more resolutions steps (including BCP steps). In some exemplary embodiments, for each deduced clause, it may be desired to obtain it using the minimal number of resolution steps that lead to it.

In this example, the deduced clauses reachable by one resolution step may be (ā [symbol] c̅) (which can be obtained based on a resolution between Legal_CNF₁ and Legal_CNF₂), ( d̅ [symbol] c [symbol] b) (which can be obtained based on a resolution between Legal_CNF₁ and Legal_CNF₃), and ( d̅ [symbol] a [symbol] b̅) (which can be obtained based on a resolution between Legal_CNF₂ and Legal_CNF₃).

Still in the same example, there is a deduced clause that is reachable by two resolutions steps: ( d̅) (which can be obtained by a resolution step between ( d̅ [symbol] c [symbol] b) and Legal_CNF₂).

There are no additional clauses that can be deduced from the CNF formula in addition to the above. As such, a method performing resolution in a Breadth First Search (BFS) order would finish after two iterations. The method may be based on the following pseudo code:

```
New Clauses=Clauses from CNF
Repeat {
    Clauses=New Clauses
    New Clauses = all resolution clauses of pair of clauses in Clauses
    New Clauses = New Clauses Union Clauses
} Until New Clauses == Clauses
```

In the present example, the derived restrictions are: (a [symbol] c), (d [symbol] c̅ [symbol] b̅), (d [symbol] ā [symbol] b̅), (d). Each derived restriction may be obtained by a negation of a deduced clause. Furthermore, it will be noted that the fourth derived restriction subsumes the second and third restrictions. As such, both the second and third restrictions may be omitted as they are not broadest restrictions. Furthermore, in case the coverage requirement is a pair-wise requirement, the second and third derived restrictions may be omitted regardless of the presence of the fourth derived restriction.

In some exemplary embodiments of the disclosed subject matter, CNF or BDD representation may be utilized to represent values of attributes. As is known in the art, non-binary domains may be mapped to a binary domain in order to encode non-binary values in a CNF or in a BDD.

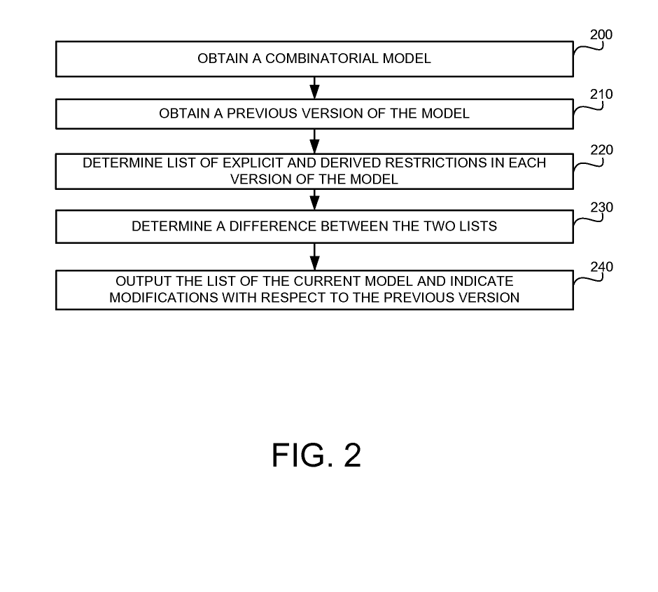

Referring now to FIG. 2 showing a flowchart diagram of a method, in accordance with some exemplary embodiments of the disclosed subject matter.

A first model is obtained (Step 200). The first model may represent a current version of the model of an SUT. A second model which represents a previous version of the model for the same SUT is obtained (Step 210). The previous version may be an immediate previous version, or a selected version such as a previously marked state (e.g., a “golden” state), which the user may decide to use as a point of comparison.

In Step 220, lists of restrictions, including derived restrictions, are determined with respect to each model. In some exemplary embodiments, the list of the previous version may have been previously determined and stored. In some exemplary embodiments, the lists may include both explicit and derived restrictions.

In Step 230, a difference between the two lists may be determined, such as identifying modified restrictions, restrictions that were added and removed, and the like.

In Step 240, the list of the first model may be displayed to the user. The list may be annotated so as to mark the changes in the lists that were determined in Step 230. As an example, new or modified restrictions may be displayed using a color different than that used to show unmodified restrictions. As another example, removed restrictions may be modified using a strikethrough. In some exemplary embodiments, the list may also be displayed so as to indicate which restrictions are derived restrictions and which are explicit restrictions, thereby allowing a user to comprehend the potentially unintentional restrictions that were added to the model in view of the modifications in the model. Similarly, the user may be able to comprehend any unintentional broadening effect on the test space (e.g., that was caused due to a derived restrictions being eliminated).

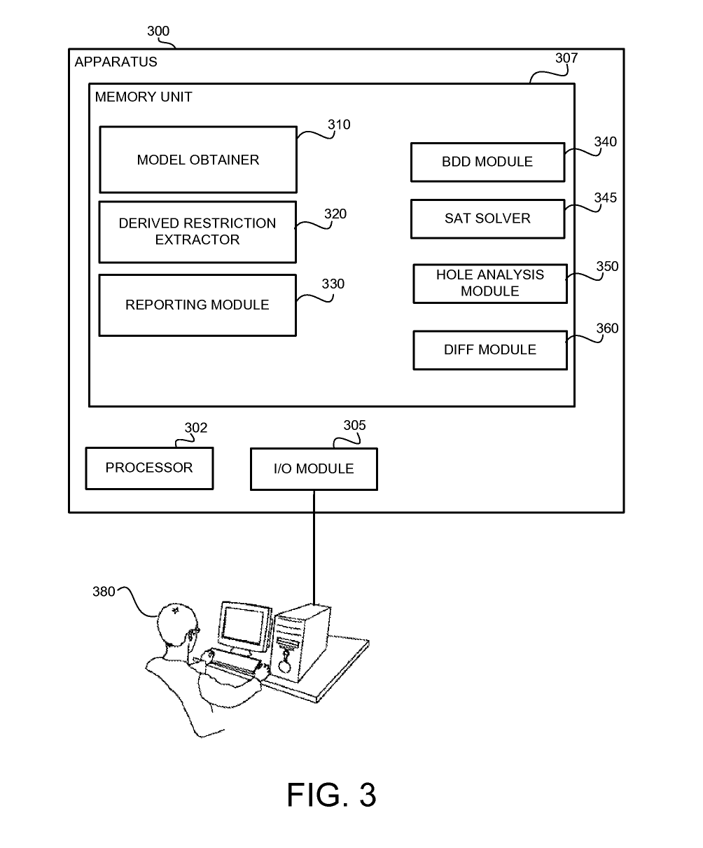

Referring now to FIG. 3 showing a block diagram of components of an apparatus, in accordance with some exemplary embodiments of the disclosed subject matter. An apparatus 300 may be a computerized apparatus adapted to perform methods such as depicted in FIGS. 1A, 1B and/or 2.

In some exemplary embodiments, Apparatus 300 may comprise a Processor 302. Processor 302 may be a Central Processing Unit (CPU), a microprocessor, an electronic circuit, an Integrated Circuit (IC) or the like. Alternatively, Apparatus 300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). The processor 302 may be utilized to perform computations required by Apparatus 200 or any of it subcomponents.

In some exemplary embodiments of the disclosed subject matter, Apparatus 300 may comprise an Input/Output (I/O) Module 305 such as a terminal, a display, a keyboard, an input device or the like to interact with the system, to invoke the system and to receive results. It will however be appreciated that the system can operate without human operation.

In some exemplary embodiments, the I/O Module 205 may be utilized to provide an interface to a User 380 to interact with Apparatus 300, such as by providing the combinatorial model, by modifying the model, by providing a coverage requirement, by viewing or reviewing output provided by Apparatus 300, or the like.

In some exemplary embodiments, Apparatus 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIGS. 1A, 1B and/or 2 above.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Model Obtainer 310 may be configured to obtain a combinatorial model, such as from a computer-readable medium and/or from User 380.

Derived Restriction Extractor 320 may be configured to extract one or more derived restrictions from a combinatorial model. Extractor 320 may be configured to utilize a SAT Solver 345 and/or a BDD Module 340 to determine the derived restrictions. In some exemplary embodiments, Extractor 320 may further utilize Hole Analysis Module 350, that is configured to perform hole analysis, to identify only broadest restrictions that are not subsumed by any other single restriction. Additionally or alternatively, Extractor 320 may determine whether a derived restriction is subsumed by another restriction and omit such subsumed restriction.

A Reporting Module 330 may be utilized to present output to User 380. The output may visually indicate which restrictions are derived and which restrictions are explicitly defined in the model. The output may indicate a difference between a current list of restrictions with a previous list. The difference may be determined by Diff Module 360 and may be indicated using a visual indication in the output.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and
automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

2. The computer-implemented method of claim 1 further comprising: providing output to a user indicating the derived restriction.

3. The computer-implemented method of claim 2, wherein the output comprising a list of restrictions defined by the combinatorial model, wherein the list includes the set of restrictions and derived restrictions; and wherein the list distinguishes between the set of restrictions and between the derived restrictions.

4. The computer-implemented method of claim 1, wherein said automatically determining the derived restriction is performed based on a coverage requirement, wherein the coverage requirement defines a level of interaction between attributes or values.

5. The computer-implemented method of claim 1, wherein said automatically determining comprises:
determining all excluded combinations from the test space based on the set of restrictions;
determining a list of holes based on the all excluded combinations, wherein the holes define excluded portions of the test space, wherein each hole is defined using an assignment to a subset of the attributes and wherein each partial assignment with respect to the assignment is not excluded from the test space;
removing from the list of holes holes that stem directly from a single restriction, thereby resulting in a remainder list; and
whereby the remainder list comprises one or more derived restrictions.

6. The computer-implemented method of claim 1, wherein said automatically determining comprises utilizing Binary Decision Diagrams (BDDs) to identify the derived restriction.

7. The computer-implemented method of claim 1, wherein said automatically determining comprises:
utilizing a Boolean Satisfiability solver, which is configured to perform resolution steps between restrictions; and
based on each clause that is an outcome of a resolution step, defining a derived restriction.

8. A computerized apparatus having a processor, the processor being adapted to perform the steps of:
obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and
automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

9. The computerized apparatus of claim 8, wherein the processer is further adapted to perform the step of: providing output to a user indicating the derived restriction.

10. The computerized apparatus of claim 9, wherein the output comprising a list of restrictions defined by the combinatorial model, wherein the list includes the set of restrictions and derived restrictions; and wherein the list distinguishes between the set of restrictions and between the derived restrictions.

11. The computerized apparatus of claim 8, wherein said automatically determining the derived restriction is performed based on a coverage requirement, wherein the coverage requirement defines a level of interaction between attributes or values.

12. The computerized apparatus of claim 8, wherein said automatically determining comprises:
determining all excluded combinations from the test space based on the set of restrictions;
determining a list of holes based on the all excluded combinations, wherein the holes define excluded portions of the test space, wherein each hole is defined using an assignment to a subset of the attributes and wherein each partial assignment with respect to the assignment is not excluded from the test space;
removing from the list of holes holes that stem directly from a single restriction, thereby resulting in a remainder list; and
whereby the remainder list comprises one or more derived restrictions.

13. The computerized apparatus of claim 8, wherein said automatically determining comprises utilizing Binary Decision Diagrams (BDDs) to identify the derived restriction.

14. The computerized apparatus of claim 8, wherein said automatically determining comprises:
utilizing a Boolean Satisfiability solver, which is configured to perform resolution steps between restrictions; and
based on each clause that is an outcome of a resolution step, defining a derived restriction.

15. A computer program product comprising :
a non-transitory computer readable medium retaining program instructions, which instructions when read by a processor, cause the processor to perform a method comprising:
obtaining a combinatorial model defining a test space, the combinatorial model comprising a set of attributes, a respective domain for each attribute defining possible values for the attribute, and a set of restrictions, wherein the restrictions define a combination of values of the attributes that are restricted from the test space; and
automatically determining a derived restriction that is derived from at least a first restriction and a second restriction, the first and second restrictions are comprised by the set of restrictions, wherein the derived restriction restricts at least one combination of values that is not restricted by the first restriction and at least one combination of values that is not restricted by the second restriction.

16. The computer program product of claim 15, wherein the instructions, when read by the processor, further cause the processor to perform: providing output to a user indicating the derived restriction.

17. The computer program product of claim 16, wherein the output comprising a list of restrictions defined by the combinatorial model, wherein the list includes the set of restrictions and derived restrictions; and wherein the list distinguishes between the set of restrictions and between the derived restrictions.

18. The computer program product of claim 15, wherein said automatically determining the derived restriction is performed based on a coverage requirement, wherein the coverage requirement defines a level of interaction between attributes or values.

19. The computer program product of claim 15, wherein said automatically determining comprises:
determining all excluded combinations from the test space based on the set of restrictions;
determining a list of holes based on the all excluded combinations, wherein the holes define excluded portions of the test space, wherein each hole is defined using an assignment to a subset of the attributes and wherein each partial assignment with respect to the assignment is not excluded from the test space;
removing from the list of holes holes that stem directly from a single restriction, thereby resulting in a remainder list; and
whereby the remainder list comprises one or more derived restrictions.

20. The computer program product of claim 15, wherein said automatically determining comprises:
utilizing a Boolean Satisfiability solver, which is configured to perform resolution steps between restrictions; and
based on each clause that is an outcome of a resolution step, defining a derived restriction.
